(19) United States
(12) Patent Application Publication
(10) Pub. No.: US 2025/0204321 A1
(43) Pub. Date: Jun. 26, 2025

(54) INSTRUMENTED END-EFFECTOR FOR HORTICULTURAL CROP MANAGEMENT TASKS

(71) Applicant: Vineland Research and Innovation Centre, Vineland Station (CA)

(72) Inventors: Brian LYNCH, Thorold (CA); Joshua LEE, Burnaby (CA); Benjamin VAN DER ZALM, Niagara-on-the-Lake (CA); Myles LIDKA, Grimsby (CA)

(73) Assignee: Vineland Research and Innovation Centre, Vineland Station, ON (CA)

(21) Appl. No.: 18/847,329

(22) PCT Filed: Mar. 28, 2023
(86) PCT No.: PCT/CA2023/050414

§ 371 Date: Sep. 16, 2024

Related U.S. Application Data
(60) Provisional application No. 63/327,508, filed on Apr. 5, 2022.

(51) Int. Cl. A01D 46/30; B25J 9/10; B25J 13/08; B25J 15/00

(52) U.S. Cl. CPC A01D 46/30; B25J 9/1035; B25J 13/084; B25J 15/0019

(57) ABSTRACT

An end-effector for a robotic manipulator arm for robotic crop management has a chassis mountable on the robotic manipulator arm and a jaw movably mounted on the chassis to permit translation of jaw on the chassis. The jaw at least partially defines a closed loop through which a horticultural object is able to pass. A tactile sensor is mounted on the end-effector to measure a force applied to the horticultural object by the end-effector as the horticultural object passes through the closed loop. A cutter mounted on the chassis cuts a portion of the horticultural object when the portion of the horticultural object is brought into contact with the cutter by translation of the jaw on the chassis. A blade sheath houses the cutting blade therein when the cutting blade is not being used.

### CROSS-REFERENCE TO RELATED APPLICATIONS

This application claims the benefit of United States Provisional Application U.S. Ser. No. 63/327,508 filed Apr. 5, 2022, the entire contents of which is herein incorporated by reference.

### FIELD

This application relates to horticulture, in particular to instrumented end-effectors for robotic crop management.

### BACKGROUND

Greenhouse fruit production, especially long English cucumber varieties, can be accomplished using a high-wire production technique, although fruit, including cucumbers, may be grown using an umbrella production or other technique. In particular, the high-wire fruit production is characterized by trellising plants along a string up to a wire from which they hang by a hook with spool of string. As the plants grow initially, the plants are maintained vertical until reaching the wire, after which further growth is accommodated by letting out string from the spool and shifting the hook laterally along the wire (called lowering). This results in the plants taking on a curved shape, with older growth starting from the root and following along the ground or trough and recent growth climbing near vertically up to the wire. As fruit grows and the plants are lowered, the fruit reaches ripeness maturity and is ready to be harvested at a consistent height within a comfortable reach of typical humans (approximately elbow to shoulder height). In addition, leaves are removed periodically (“de-leafing”) to improve air flow and maintain nutrient balance in the plants, but also resulting in the fruit being more exposed and therefore easier to find and harvest.

To reduce the cost of growing and harvesting for greenhouse fruit growers, an automation solution that is competitive with respect to human labor is desirable. Harvesting is defined as the action of removing appropriate (i.e., ripe) fruit from the plants and placing them in a container that can later be transferred to a sorting and packing area. A completely autonomous solution for harvesting would be required to navigate the greenhouse safely, decide on what areas need harvesting, mount and dismount on and off of pipe rails, harvest fruit, and deliver harvested fruit to a packing and sorting area. However, the fundamentally challenging aspect of this problem is harvesting the fruit. All other aspects of a fully autonomous solution are relatively easier to develop in comparison. Therefore, the focus of robotic fruit harvesting is to develop a solution that drives along the rows of a greenhouse, detects and localizes ripe fruit, reaches out and harvests the fruit, and places it in a container. The system is desirably manually driven when not on pipe rails performing harvesting actions (i.e., manually driven between rows and manually mounted and dismounted onto and off of pipe rails).

To this end, there are three main categories of technical challenges: vision (detecting and locating ripe fruit); robotics (positioning a harvesting tool (end-effector) at the fruit); and, harvesting (cutting the stem, gripping the fruit, and extracting the fruit). The elements of harvesting (cutting, gripping, and transferring) present some challenges that must be addressed primarily through end-effector design but also may have implications for vision and robotics components. Fruit stem needs to be cut cleanly, reliably, and quickly, and needs to be cut at an appropriate location (only a small portion of stem should be remaining on the fruit itself). A major challenge is detecting and localizing the appropriate cutting location. While many fruits, including cucumber, are not particularly fragile there does need to be consideration for handling the fruit gently enough to prevent damage. This is also important when placing the fruit in a container after harvesting.

Standard off-the-shelf robotic end-effectors are unable to perform harvesting. Thus, there remains a need for an end-effector for a robotic manipulator that can meet the technical challenges of harvesting fruit or vegetables growing from a stem.

### SUMMARY

An end-effector for a robotic manipulator arm for robotic crop management is provided. The end-effector comprises: a chassis mountable on the robotic manipulator arm; a jaw movably mounted on the chassis to permit translation of jaw on the chassis, the jaw at least partially defining a closed loop through which a horticultural object is able to pass; a tactile sensor mounted on the end-effector configured to measure a force applied to the horticultural object by the end-effector as the horticultural object passes through the closed loop; and, a cutter mounted on the chassis, the cutter configured to cut a portion of the horticultural object when the portion of the horticultural object is brought into contact with the cutter by translation of the jaw on the chassis.

The jaw is the component of the end-effector, which primarily interacts with the horticultural object. In some embodiments, the jaw comprises parallel sides. In some embodiments, the jaw comprises arms joined at an apex at a distal end of the end-effector. The parallel sides and the arms at least partially define the closed loop. In some embodiments, the jaw comprises at least one jaw roller oriented into the closed loop. The at least one jaw roller rotatable in response to the horticultural object moving through the closed loop and in contact with the at least one jaw roller. The at least one roller to assist motion of the horticultural object through the closed loop to minimize damage that may be caused to the horticultural object by rubbing and abrasion. The at least one jaw roller preferably comprises at least two jaw rollers, at least one of the at least two jaw rollers mounted on each of the arms.

The chassis is preferably fixedly mountable on the robotic manipulator arm so that the chassis does not move independently of the robotic manipulator arm during operation of the end-effector. The chassis has a proximal end closer to the robotic manipulator arm and a distal end farther from the robotic manipulator arm. A longitudinal axis of the end-effector runs between the proximal and distal ends of the chassis. In operation, the longitudinal axis is preferably oriented horizontally, that is, parallel to the ground. The chassis provides a fixed structure on which the jaw is translatably mounted. In some embodiments, the chassis comprises parallel guide carriages situated at sides of the chassis. The parallel sides of the jaw each comprise a guide rail on which one of the parallel guide carriages is mounted. The guide rails slide on the guide carriages as the jaw translates on the chassis.

Translation of the jaw is accomplished with an actuator, for example a linear actuator (e.g., a rod and cylinder actuator, a motor or the like), a hydraulic cylinder, a pneumatic cylinder or the like. In some embodiments, the actuator drives a rack-and-pinion mechanism which provides smooth, frictionless motion of the guide rails in the guide carriages. With the rack-and-pinion mechanism, the actuator and a pinion gear may be mounted on the chassis and a toothed rack mounted on the jaw. The pinion gear is rotatably connected to the actuator and operatively engaged with the toothed rack. Actuation of the actuator causes the jaw to translate linearly on the chassis. Preferably, the actuator is reversible so that the jaw can be translated both distally and proximally. In some embodiments, the jaw can be translated along an arcuate track, but it is preferably for simplicity and accuracy of motion that the jaw is translated along a linear track.

The cutter may comprise, for example, a cutting blade (e.g., a prismatic cutting blade, a scissor cutting device, a rotary cutting blade, a reciprocating cutting blade or the like), a pyrotechnic cutting device, a laser cutting device or the like. In some embodiments, the cutter comprises a cutting blade, preferably a prismatic cutting blade, immovably mounted on the chassis. The cutting blade has a cutting edge oriented into the closed loop.

The tactile sensor may be any sensor capable of measuring a force applied to the horticultural object by the end-effector. Depending on the nature of the sensor, the tactile sensor may be mounted anywhere on the end-effector, for example on the arms of the jaw where the sensor can be in direct contact with the horticultural object. However, in some embodiments, the tactile sensor may be mounted on the chassis in such a manner that forces applied to the horticultural object are transmitted indirectly to the tactile sensor. In some embodiments, the tactile sensor comprises a force-sensitive resistor. In some embodiments, the force-sensitive resistor is mounted on the chassis and the end-effector further comprises a floating bearing block mounted on the chassis between the force-sensitive resistor and the closed loop whereby the force applied to the horticultural object by the end-effector as the horticultural object passes through the closed loop is transmitted to the force-sensitive resistor through the floating bearing block.

Other sensors to assist with proper placement of the end-effector may be provided on the end-effector or robotic manipulator arm, for example photometric sensors, actuator position sensors, actuator effort sensors, capacitive sensors, vision sensors (e.g., cameras, especially 3D cameras) and proximity sensor.

The end-effector may further comprise a blade sheath for housing the cutting blade therein when the cutting blade is not being used. The blade sheath protects the horticultural object from inadvertent damage. The blade sheath is preferably mounted on the chassis. In some embodiments, the blade sheath is a translatable blade sheath. In some embodiment, the blade sheath is retractable. The blade sheath is preferably retractable in response to the jaw translating to bring the portion of the horticultural object into contact with the cutting edge of the cutting blade. To prevent the blade sheath from moving when the cutting blade is not being used, latches may be used to secure the blade sheath to the chassis (or the bearing block mounted on the chassis). In some embodiments, the jaw comprises latch releases that engage the latches to release the latches as the jaw translates so that the jaw contacts the blade sheath to push the blade sheath thereby unsheathing the cutting blade. In some embodiments, the latches comprise a ratchet-style hook. In some embodiments, the latch releases comprise a cam-style hook release whereby a cam engages with the latch to open the latch. In some embodiments, the latches are spring-loaded to bias the latches back into engagement with the chassis (or the bearing block mounted on the chassis) to re-secure the blade sheath around the cutting blade once the cutting operation is completed. In some embodiments, the blade sheath is spring-loaded to return the blade sheath to position to re-sheathe the cutting blade. In some embodiments, the blade sheath together with the jaw define the closed loop. The blade sheath may also comprise at least one sheath roller rotatable in response to the horticultural object moving through the closed loop and in contact with the at least one sheath roller to minimize damage that may be caused to the horticultural object by rubbing and abrasion.

In some embodiments, the end-effector further comprises a gripper that grips the horticultural object when the cutter cuts the portion of the horticultural object when the portion of the horticultural object is brought into contact with the cutter by translation of the jaw on the chassis. In some embodiments, the gripper comprises a pinch gripper connected to the chassis and a jaw tab connected to the jaw. The pinch gripper and jaw tab have gripping surfaces between which the horticultural object is gripped. The gripping surfaces may comprise rubber pads to provide greater frictional force.

In operation, the end-effector comprises a closed loop that is first placed below a horticultural object and lifted upwards by the robotic manipulator arm to completely encircle the horticultural object inside the closed loop of the end-effector. Once a horticultural object has entered the closed loop, the jaw is retracted, gently clamping around the horticultural object. The robotic manipulator arm that carries the end-effector is commanded to move upwards at a speed that is related to the linear position of the jaw on the chassis, moving relatively fast if the jaw is open, indicating the end-effector is enclosed around the body of the horticultural object, and slowing down as the jaw closes further on a shoulder and then a stem of the horticultural object. The robotic manipulator arm also tracks a centerline position and angle of the horticultural object to ensure a smooth “threading the needle” approach. The actuator used to translate the jaw may have an encoder providing position feedback for the jaw.

The end-effector “feels” the way up the horticultural object to a cutting portion of the horticultural object (e.g., a stem). A programmed logic controller is electronically coupled (wirelessly or wired, preferably wirelessly) to various equipment (e.g., a camera, a robot with the robot manipulator arm, the end-effector and any other device to be used in conjunction with the end effector). The tactile sensor is in electronic communication with the controller providing force data to the controller. The controller using the force data to control translation of the jaw so that the horticultural object remains in contact with the end-effector within the closed loop without being outside a specified contact force range. The controller may be mounted on the end-effector or may be a remote controller. Thus, the end-effector comprises a jaw that slides distally and proximally to close or open on the horticultural object, whereby the longitudinal position of the jaw on the end-effector is adjusted to maintain contact (without significant force) based on closed-loop control with feedback from the tactile sensor. The sliding jaw's position is maintained to remain in contact with the horticultural object with little to no compressive force.

Once the end-effector reaches the cutting portion, the jaw has closed to a position and the upward motion of robotic manipulator arm is stopped. The controller sends a command to cut the cutting portion and the cutting portion is cut. Preferably, the horticultural object is also gripped, allowing the horticultural object to be removed and stored. Cutting is accomplished by further translating the jaw proximally, which pushes the cutting portion further towards the cutter. The cutter is fixed and the cutting portion of the horticultural object is simply pushed into the cutter. In embodiments that employ a cutting blade and a blade sheath, retraction of the jaw causes the jaw to interact with the blade sheath thereby pushing back the blade sheath to expose the cutting blade, against the cutting edge of which the cutting portion of the horticultural object is forced. The horticultural object is thereby cut by the blade, separating the horticultural object from the plant.

Gripping the cutting portion (e.g., the stem) of the horticultural object with the gripper allows the cutting portion of the horticultural object to be pinched while cutting occurs, after which the horticultural object has been removed from the plant but remains in the grip of the end-effector.

Operation of the end-effector, as well as the robotic manipulator arm, may be controlled by a controller, for example an Arduino microcontroller, a programmed logic controller (PLC) or any other suitable controller, in electronic communication with the actuator on the end-effector (and any actuators on the robot and robotic manipulator arm) and with the various sensors. Feedback from the sensors is evaluated by the controller and control performed based on instructions in the form of software encoded into the controller. The controller can be electronically linked to a user interface (e.g., a control box or panel) for control or override by a human operator. The user interface may comprise one or more input devices (e.g., buttons, keyboards, computer mice, microphones or the like) and one or more output devices (e.g., monitors, printers, speakers, headphones, projectors, GPS devices or the like). The controller may be linked to the actuator and various other devices and to the various sensors either wirelessly or through wired connections.

The horticultural object is preferably a part of a plant. The end-effector is especially useful for removing parts of plants, for example, in harvesting operations. The end-effector is more especially useful for harvesting fruit and vegetables growing from a stem attached to a plant, especially a vine plant. Some examples of fruits and vegetables are cucumbers (e.g., long English varieties, miniature varieties, and the like), apples, pears, oranges, peppers (e.g., bell, pointed and the like), tomatoes (e.g., beefsteak, hothouse and the like), eggplants, strawberries and the like. The end-effector permits harvesting fruit and vegetables, especially cucumber, most especially long English variety cucumber, whereby the stem is cut cleanly, reliably, quickly and at an appropriate location with only a small portion of stem remaining on the fruit itself. The end-effector can be used for other crop management tasks, for example, de-leafing, pruning, or other tasks requiring plant parts to be removed. The end-effector is especially useful in a greenhouse setting, although with appropriate robot design, the end-effector can be employed in a field setting as well.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a perspective view of an end-effector of the present invention.

FIG. 2 depicts a top view of the end-effector of FIG. 1.

FIG. 3 depicts a section view of the end-effector of FIG. 2 through section A-A.

FIG. 4 depicts a top view of the end-effector of FIG. 1 with a cutting blade exposed.

FIG. 5A depicts a side view of the end-effector of FIG. 1 with a jaw in a retracted position.

FIG. 5B depicts the end-effector of FIG. 5A with the jaw in an extended position.

FIG. 5C depicts the end-effector of FIG. 5B with an English variety cucumber to be harvested.

FIG. 6A depicts a top view of the end-effector of FIG. 1.

FIG. 6B depicts the end-effector of FIG. 6A in a gripping configuration.

FIG. 6C depicts a section view of the end-effector of FIG. 6B through section B-B.

FIG. 7A depicts a perspective view of rollers at a distal end of the end-effector of FIG. 1.

FIG. 7B depicts an alternate perspective of FIG. 7A.

FIG. 7C depicts a top view of FIG. 7A.

FIG. 7D depicts a section view of FIG. 7C through section C-C at a scale of 1:2.

FIG. 8A depicts a top view of the end-effector of FIG. 1 with a guide carriage removed to show hooked latches in an engaged configuration.

FIG. 8B depicts the end-effector of FIG. 8A with the hooked latches in a disengaged configuration.

FIG. 9A depicts a bottom view of the end-effector of FIG. 1 showing sheath return springs in a retracted configuration to expose a cutting blade.

FIG. 9B depicts the end-effector of FIG. 9A with the sheath return springs in an extended configuration to sheath the cutting blade FIG. 10A depicts a top view of the end-effector of FIG. 1 with an open jaw ready to encircle a fruit to be harvested.

FIG. 10B depicts the end-effector of FIG. 1 with the jaw retracted so that a body of the fruit is in contact with both jaw rollers and sheath rollers of the end-effector.

FIG. 10C depicts the end-effector of FIG. 1 with the jaw retracted so that a stem of the fruit is between the rollers of the end-effector.

FIG. 10D depicts the end-effector of FIG. 10C with the jaw further retracted to release hooked latches.

FIG. 10E depicts the end-effector of FIG. 10D with the jaw further retracted so that a cutting blade cuts the stem of the fruit.

FIG. 11 depicts a flowchart for an overall harvesting strategy using the end-effector of FIG. 1.

### DETAILED DESCRIPTION

The drawings show an end-effector 1 for automated crop management. The end-effector 1 has a longitudinal axis extending between a proximal end 2, to which a robotic manipulator arm is mountable, and a distal end 3, where fruit harvesting is performed. The end-effector 1 comprises a chassis 10, a translatable jaw 30 mounted on the chassis 10, a translatable blade sheath 50 mounted on the chassis 10 and a floating bearing block 70 situated between the blade sheath 50 and a body 12 of the chassis 10.

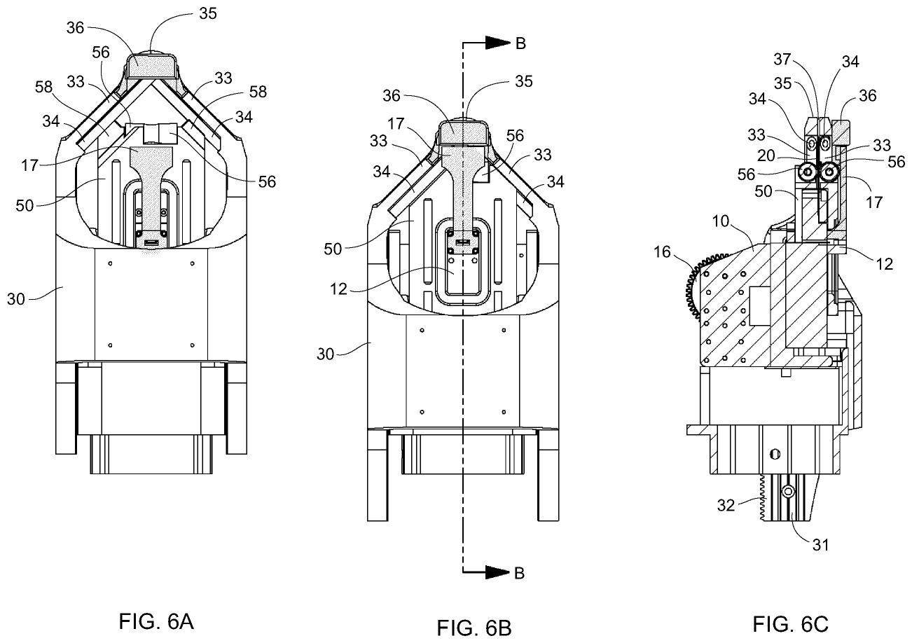

The chassis 10 comprises a mount 11 at the proximal end 2 of the end-effector 1 for mounting the end-effector 1 on the robotic manipulator arm. The chassis 10 further comprises two parallel guide carriages 13 (only one labeled) extending longitudinally, one on each side of the chassis 10 and a support plate 14 mounted on top of the chassis 10 for supporting an actuator (e.g., a rotary servo motor) 15 securely mounted on the support plate 14. The actuator 15 rotationally drives a pinion gear 16, the actuator 15 capable of driving the pinion gear 16 in both rotational directions, the pinion gear 16 having a rotation axis oriented transversely with respect to the longitudinal axis of the end-effector 1. The chassis 10 further comprises a force sensitive resistor 19 mounted on the body 12 between the body 12 and the floating bearing block 70. The force sensitive resistor 19 is in electronic communication with a controller providing force data to the controller, the controller using the force data to control the actuator 15. The chassis 10 further comprises a pair of longitudinally oriented transversely spaced-apart guide rods 21 mounted on a distal-facing face of the body 12. The blade sheath 50 is mounted in the guide rods 21. A cutting blade 20 is fixedly attached to a distal end of the body 12, a distal cutting edge of the cutting blade 20 sharpened to be able to cut a stem 91 of a fruit 90 (e.g., a cucumber). The chassis 10 further comprises a pinch gripper 17, which is shown in FIG. 6A to FIG. 6C but omitted from the other drawings. The pinch gripper 17 is situated below the cutting blade 20 and extends distally from the body 12 so that a distal end of the pinch gripper 17 is not as far distally as the distal cutting edge of the cutting blade 20. The pinch gripper 17 comprises a leg connected to the chassis 10 and a head having a gripping surface against which the stem 91 is held when the stem 91 is gripped. The chassis 10 and all of the components thereof only move with the robotic manipulator arm and are not otherwise independently moveable during a harvesting operation.

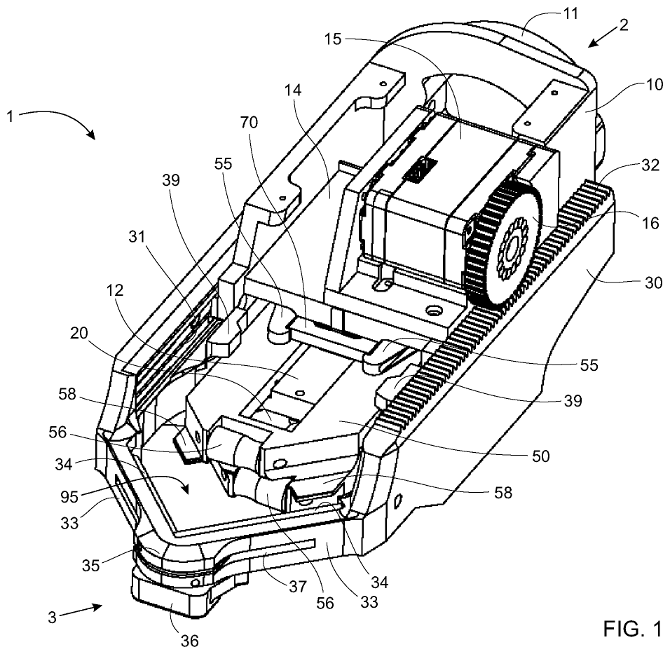

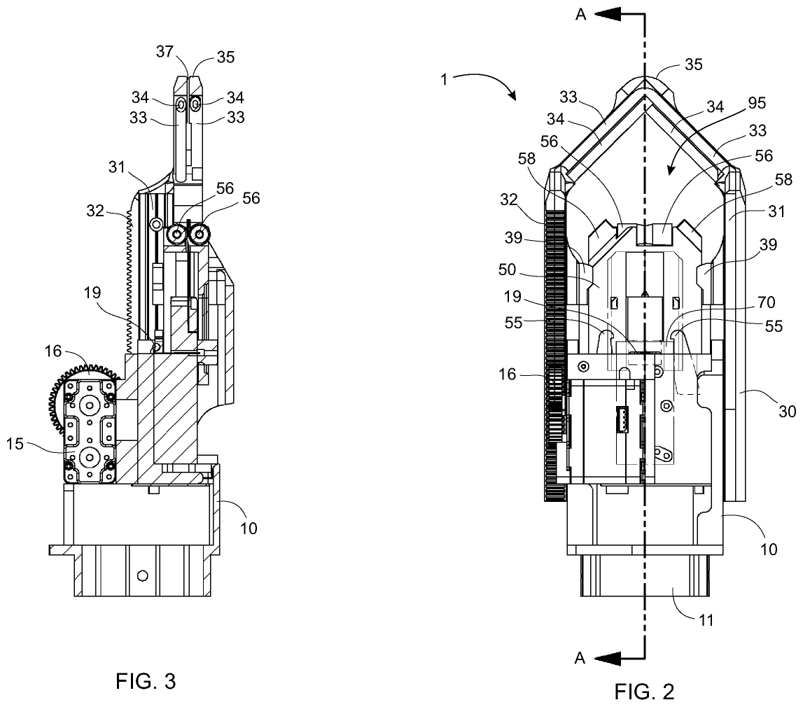

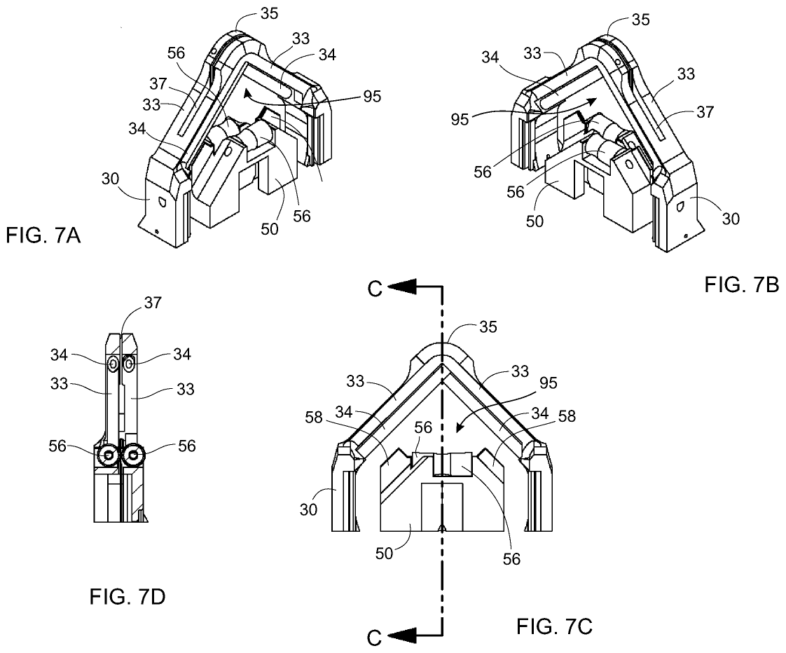

The translatable jaw 30 comprises two parallel sides, each side having a longitudinally extending guide rail 31 (only one shown) in the form of a longitudinal channel in an inner-facing surface each of the sides, the guide rails 31 mating with the guide carriages 13 of the chassis 10. The guide rails 31 are slidingly mounted on the guide carriages 13 so that the jaw 30 can translate linearly and longitudinally both distally and proximally on the chassis 10. The jaw 30 further comprises a toothed rack 32 affixed to an upper surface of one of the sides, the teeth of the toothed rack 32 engaging with teeth of the pinion gear 16 to form a rack-and-pinion mechanism so that rotation of the pinion gear 16 is translated into linear longitudinal translation of the jaw 30. The jaw 30 further comprises two arms 33 connected to distal ends of respective sides, the arms 33 extending distally and inwardly to meet at an apex 35, which is the distal-most point of the end-effector 1 where the two arms 33 are connected, thereby forming a closed loop bounded by the jaw 30 and the body 12, the closed loop defining a circumferentially-bounded fruit-receiving opening 95 for receiving a fruit therein during the harvesting operation. On inner surfaces of each of the arms 33 are mounted two jaw rollers 34, an upper roller and a lower roller for each arm 33 for a total of four jaw rollers 34. The jaw 30 further comprises a jaw tab 36 located on an underside of the arms 33 at the apex 35, the jaw tab 36 being shown in FIG. 1 and FIG. 6A to FIG. 6C but omitted from the other drawings. The jaw tab 36 extends into the fruit-receiving opening 95 and has a surface against which the stem 91 is held when the stem 91 is gripped. Each of the arms 33 are divided into upper and lower portions by a blade slot 37 and the upper and lower jaw rollers 34 of each arm 33 are separated by a gap corresponding to the location of the blade slot 37 so that during a stem-cutting step of the harvesting operation, the blade slot 37 can accommodate the cutting blade 20 to ensure a complete and clean cut of the stem 91. The sheath rollers 56 are asymmetric and transversely offset from each other (see FIG. 7B and FIG. 7C) to avoid interference with the jaw rollers 34 during cutting. Situating the rollers 34, 56 above and below the blade slot 37 ensures that the stem 91 is cut with a double shear constraint condition, reducing the risk that the cutting blade simply 20 pushes and/or bends the stem 91 instead of cutting the stem 91. The jaw 30 further comprises two cammed latch releases 39, one on each side of the jaw 30.

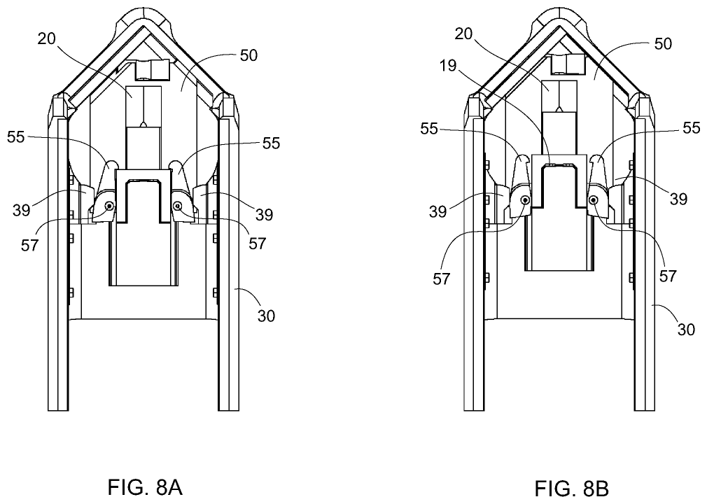

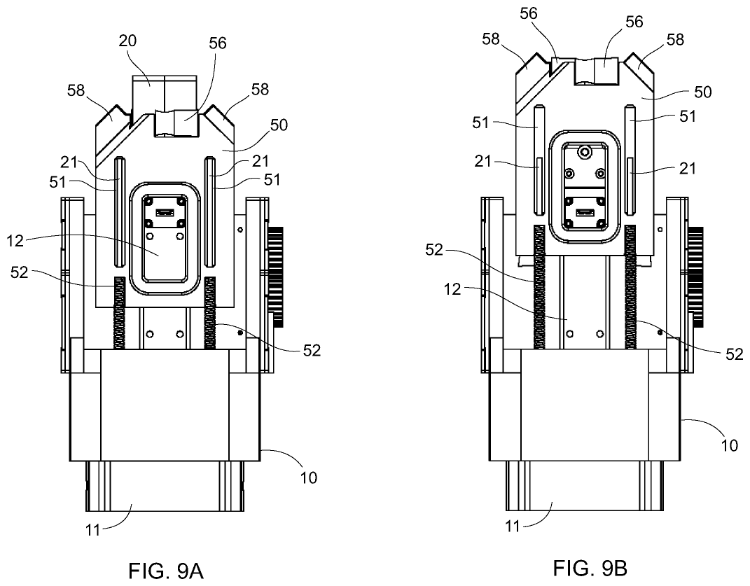

The translatable blade sheath 50 comprises upper and lower sheath plates having a gap therebetween for housing the cutting blade 20. Inside the blade sheath 50 are a pair of longitudinally oriented transversely spaced-apart bores 51 opening at a proximal-facing face of the blade sheath 50, the bores 51 aligned with the guide rods 21 in order to mount the blade sheath 50 on the guide rods 21, as best seen in FIG. 9A and FIG. 9B The blade sheath 50 further comprises a pair of helical compression springs 52 in which the guide rods 21 are situated, proximal ends of the springs 52 being seated against the distal-facing face of the body 12 and distal ends of the springs seated against shoulders formed inside the bores 51. Because the guide rods 21 have a smaller diameter than the springs 52 in order to fit within the helices of the springs 52, distal portions of the bores 51 have smaller diameters than proximal portions thereby forming the shoulder where the two different diameters within each of the bores 51 meet. The blade sheath 50 further comprises two spring-loaded hooked latches 55, which are pivotally mounted on the blade sheath 50 by pivot pins 57. The hooks of the latches 55 engage with the floating bearing block 70 to hold the floating bearing block 70 against the body 12 thereby securing the blade sheath 50 to the body 12 (see FIG. 8A) so that the blade sheath 50 remains immovable with the body 12. In this circumstance, the helical compression springs 52 are mostly uncompressed but are under a small pre-load (see FIG. 9B) so that the springs 52 do not rattle in the bores 51. Interaction of the cammed latch releases 39 with the latches 55 causes the latches 55 to disengage from the floating bearing block 70 thereby allowing the blade sheath 50 to translate longitudinally relative to the body 12. To this end, the blade sheath 50 comprises abutment flaps 58 that engage with the arms 33 of the jaw 30 to permit retraction of the jaw 30 to retract the blade sheath 50 by pushing the blade sheath 50 proximally when the latches 55 are unlatched. In this circumstance, the helical compression springs 52 are compressed in the bores 51 (see FIG. 9A). The latches 55 can be re-engaged with the floating bearing block 70 on extension of the jaw 30 by virtue of latch springs (not shown) of the spring-loaded latches 55 biasing the hooks back into engagement with the floating bearing block 70. The blade sheath 50 further comprises two sheath rollers 56, including an upper and lower sheath roller, situated at a distal end of the blade sheath 50 facing into the fruit-receiving opening 95. The sheath rollers 56 define a portion of a proximal half of the fruit-receiving opening 95 and the jaw rollers 34 define a portion of a distal half of the fruit-receiving opening 95, the sheath rollers 56 together with the jaw rollers 34 permitting the end-effector 1 to be vertically moved freely even when the fruit 90 is gripped between the rollers 34 and 56 during the harvesting operation.

The floating bearing block 70 comprises a U-shaped plate that is not fixedly secured to the body 12 but is mounted thereon as a structure to which the blade sheath 50 may be latched to secure the blade sheath 50 to the body 12 during a first portion of the harvesting operation while permitting longitudinal translation of the blade sheath 50 once the latches 55 are disengaged to expose the cutting blade 20 during a stem-cutting portion of the harvesting operation. Further, the floating bearing block 70 provides a free moving surface that engages with the force sensitive resistor 19 in order to provide a measurement of the forces that the end-effector 1 is applying to the fruit 90 during the harvesting operation.

Now that the various elements of the end-effector 1 have been described operation of the end-effector will be described.

Generally, the end-effector 1 is designed as a closed loop that is configured to close on the fruit 90 (or other object) inside of the fruit-receiving opening 95. The body 12 is fixed to a robotic manipulator arm and does not move except when the robotic manipulator arm moves. The jaw 30 is the main component that is actuated to translate longitudinally to close or open the fruit-receiving opening 95 as the fruit passes through the fruit-receiving opening 95. The blade sheath 50 at the sheath rollers 56 acts as a fixed inner contact point for the fruit 90 during closure before cutting, but slides proximally to reveal the cutting blade 20, which is fixed to the body 12, when cutting is desired. Control of the actuator 15, and therefore control of the jaw 30, by the controller is based on feedback from the force sensitive resistor to ensure that gentle contact is maintained between the fruit 90 inside the fruit-receiving opening 95 and both the jaw 30 and the blade sheath 50. The end-effector 1 will close gently on the fruit 90 as the fruit 90 passes vertically down through the fruit-receiving opening 95 when the end-effector 1 is being raised by the robotic manipulator arm, then the end-effector 1 will maintain contact and eventually close gently on the stem 91. The jaw rollers 34 and the sheath rollers 56 allow the fruit 90 to pass vertically through the fruit-receiving opening 95 without rubbing or abrasion.

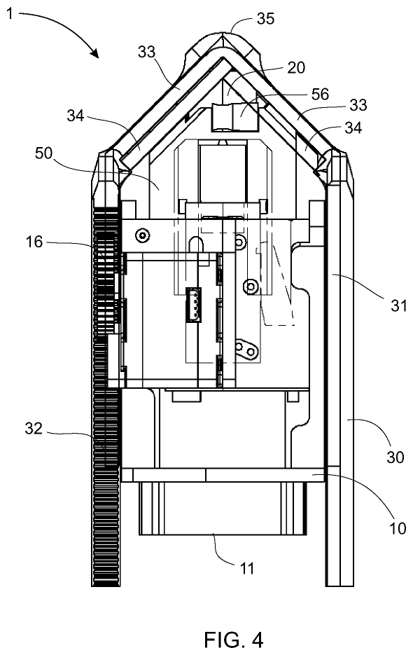

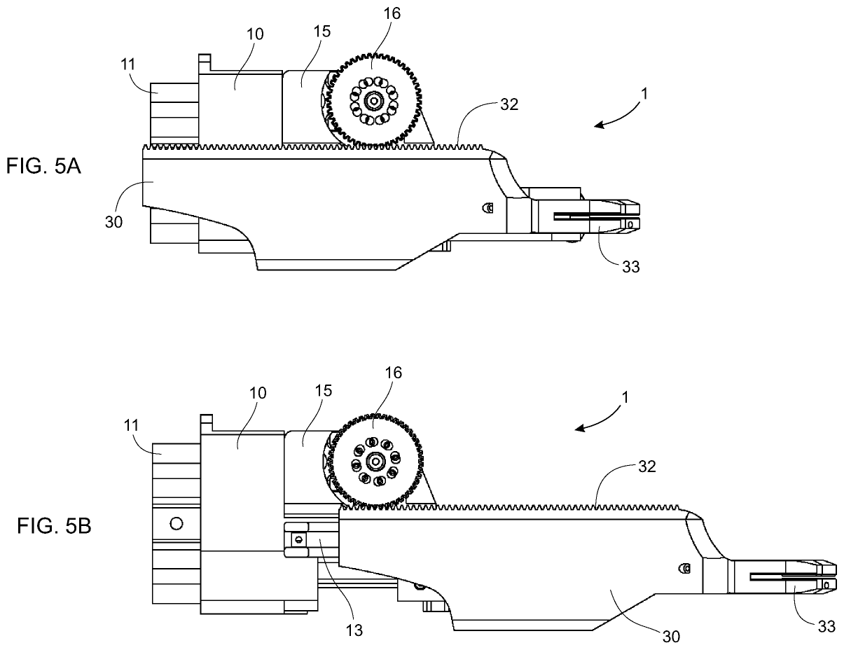

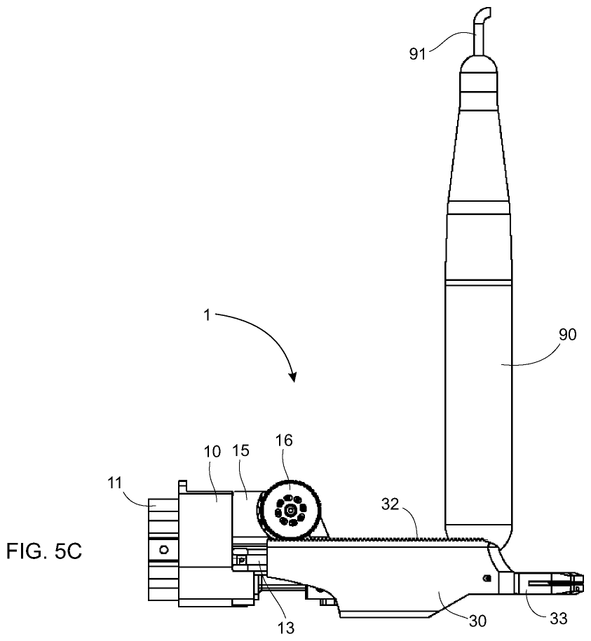

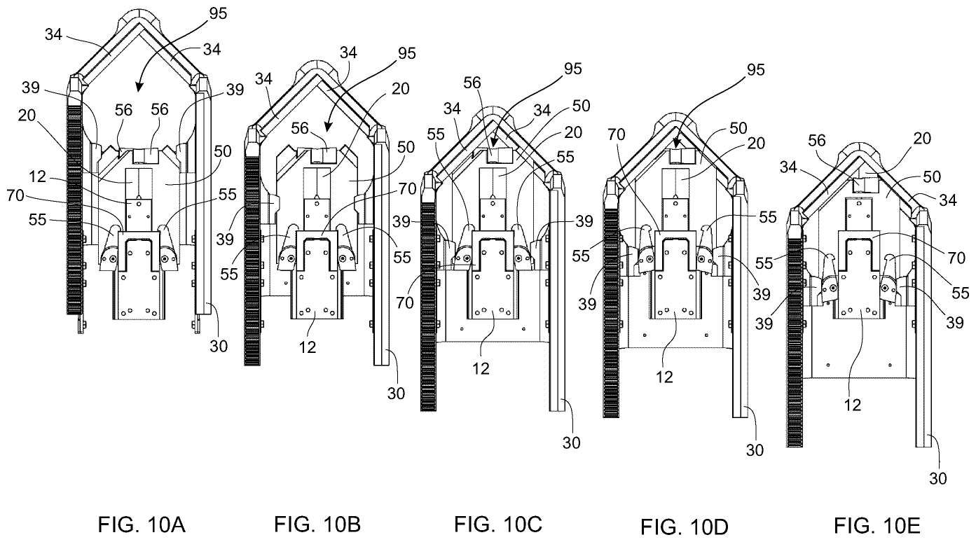

With reference in particular to FIG. 5A to FIG. 5C, FIG. 6A to FIG. 6C and FIG. 10A to FIG. 10C, the jaw 30 can be actuated by the actuator 15 to translate on the chassis 10 between a fully longitudinally extended position (FIG. 5B and FIG. 5C) and a longitudinally retracted position (FIG. 5A). As discussed above, the pinion gear 16 of the chassis 10 is meshed with the toothed rack 32 of the jaw 30 whereby rotational motion of the pinon gear 16 by the actuator 15 causes linear motion of the jaw 30. With the jaw 30 in the fully extended position, the fruit-receiving opening 95 is large enough to accept the fruit 90 therein (see FIG. 5C and FIG. 10A). With the fruit-receiving opening 95 below the fruit (FIG. 3C), the end-effector 1 can be raised by the robotic manipulator arm so that the fruit 90 is fully encircled in the fruit-receiving opening 95 by the closed loop. When the jaw 30 is retracted, the fruit-receiving opening 95 becomes smaller until the fruit 90 is contacted by the jaw rollers 34 and the sheath rollers 56 (FIG. 6A, FIG. 10B). Gripping force is transmitted through the end-effector 1 to the force sensitive resistor 19. During closure of the fruit-receiving opening 95, compressive force on the fruit 90 causes a reaction force on the blade sheath 50 through the sheath rollers 56. The reaction force on the blade sheath 50 is transferred to the latches 55, which then transfer the reaction force to the floating bearing block 70, which then transfers the reaction force to the body 12 through the force sensitive resistor 19 which is installed between the floating bearing block 70 and the body 12. The force sensitive resistor 19 transmits force data electronically to the controller, which controls the actuator 15 to move the jaw 30 distally and proximally so that as the fruit 90 moves through the fruit-receiving opening 95 while the end-effector 1 is raised, the gripping force remains within a certain range between a lower force threshold and an upper force threshold to ensure that the rollers 34, 56 remain in contact with the fruit 90 without damaging the fruit 90. When the end-effector 1 is raised enough so that the stem 91 of the fruit 90 is between the rollers 34, 56 and the jaw 30 is in the retracted position (see FIG. 6A and FIG. 10C), it is assumed that the end-effector 1 is at the stem 91. At this point, the stem 91 is ready to be gripped and cut. The operation described above to bring the end-effector 1 to the stem 91 is done automatically, but once the end-effector 1 is at the stem 91, the end-effector 1 waits for the controller to send a further command to begin a cutting operation.

As seen in FIG. 10D, when the command to cut the stem 91 is received by the end-effector 1, continued translation of the jaw 30 in a proximal direction causes the cammed latch releases 39 to unlatch the hooked latches 55 from the floating bearing block 70, releasing the connection of the blade sheath 50 to the body 12. As seen in FIG. 10E, further continued translation of the jaw 30 in a proximal direction after unlatching the blade sheath 50 causes the jaw 30 to push the blade sheath 50 in a proximal direction. The arms 33 of the jaw 30 contact the blade sheath 50 at the abutment flaps 58 so that further retraction of the jaw 30 pushes the blade sheath 50 proximally thereby exposing the cutting blade 20 (see FIG. 9A) and bringing the pinch gripper 17 into contact with the jaw tab 36 (see FIG. 6B and FIG. 6C) to grip the stem 91 therebetween. The retracting jaw 30 pushes the blade sheath 50 proximally against the compression springs 52 (see FIG. 9B) to simultaneously expose the cutting blade 20 and bring the stem 91 toward the cutting blade 20. Because the jaw tab 36 protrudes sufficiently into the fruit-receiving opening 95, and the pinch gripper 17 does not extend as far distally as the cutting blade 20, the stem 91 is gripped between the pinch gripper 17 and the jaw tab 36 below the cutting blade 20 just as the cutting blade 20 cuts the stem 91. During the entire cutting operation, the cutting blade 20 does not move. The stem 91 is pushed into the cutting edge of the cutting blade 20.

After the stem 91 is cut, the end-effector 1 is moved by the robot manipulator arm into position over a storage container, and the actuator 15 is actuated to extend the jaw 30 distally. Extension of the jaw 30 causes the pinch gripper 17 and the jaw tab 36 to separate thereby releasing the stem 91 causing the fruit 90 to fall into the storage container. Further, as the jaw 30 extends, the blade sheath 50 is pushed distally by the compression springs 52 to re-sheath the cutting blade 20 (see FIG. 9A and then FIG. 9B for the re-sheathing operation). Further, as the jaw 30 translates distally, the cammed latch releases 39 travel past the spring-loaded hooked latches 55 and the latch springs force the latches 55 back into engagement with the floating bearing block 70 to reset the blade sheath 50 in position around the cutting blade 20 and to hold the blade sheath 50 to the body 12.

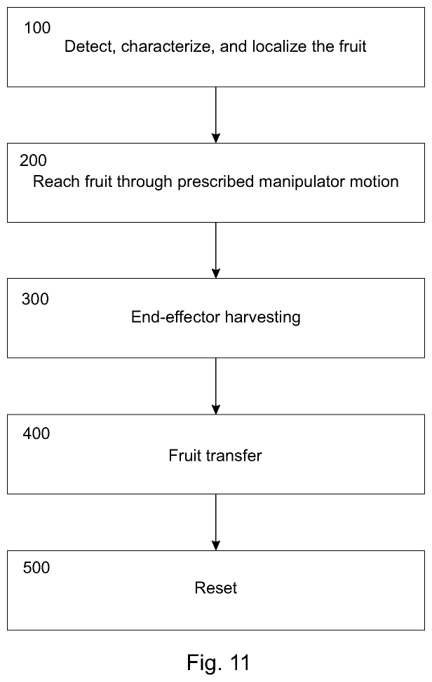

With reference to FIG. 11, in an overall harvesting strategy, a programmed logic controller electronically coupled (wirelessly or wired, preferably wirelessly) to various equipment (a camera, a robot with a robot manipulator arm, the end-effector 1) is used to detect fruit through deep learning, assess ripeness based on diameter, use a robotic manipulator arm to place the end-effector 1 at the fruit, and then have the end-effector 1 climb up the fruit body and detect the stem location after which the stem is cut and the fruit transferred to a storage container on the robot. By using the end-effector 1 to find the stem instead of depending on a vision solution, the requirements for 3D scanning and computer vision processing are greatly reduced and the robot is able to harvest more effectively. In the context of a long English cucumber variety, the harvesting operation involves the following steps.

### Detect, Characterize, and Localize the Fruit 100

A vision system is used to provide coarse localization of fruit (centroid, bottom, and/or top), but cannot be relied upon to find the stem of the fruit. Detection is performed using deep learning to provide instance segmentation results on colour (RGB) images generated by a 3D camera. For each instance of fruit detected, the corresponding 3D points provided by the camera are separated and noise is filtered. Ripeness is characterized by determining diameter of the upper ⅓ of the segmented set of 3D points. A centerline “spline” curve is generated that characterizes the shape of the fruit as fitted to 2 polynomial curves (one in each axis perpendicular to the spline). The resulting points defining the fruit are then transformed to a world coordinate frame based on the estimated robot position provided through dead reckoning by wheel odometry. Fruits are tracked in the world coordinate frame between images to update parameters and avoid repeats in the detected fruit (fruit are stored in a list ordered from left to right such that the first fruit in the list is the next one to be harvested as the robot moves from left to right).

### Reach Fruit Through Prescribed Manipulator Motion 200

As the first fruit in the tracking list enters the manipulator workspace, the manipulator is controlled to place the fruit-receiving opening 95 of the end-effector 1 at the bottom of the spline and then track up the spline maintaining an orientation perpendicular to the spline until the end-effector 1 reaches a specified fraction of the spline length. After reaching the specified spline length fraction, a command is issued by the controller to start the end-effector stem-sensing and harvesting process.

### End-Effector Harvesting 300

End-effector harvesting involves operating the end-effector 1 as described above to close the j end-effector 1 on the fruit 90 while maintaining gentle contact based on sensing the contact force with the force-sensitive resistor 19. The robot manipulator arm is commanded to continue upwards motion with a speed that is non-linearly proportional to the speed of the jaw 30, causing the end-effector 1 to climb up the fruit 90 at a speed that is related to the width of the fruit 90 at the point of contact. When the end-effector 1 reaches the fruit stem 91 the fruit-receiving opening 95 has reached a most-closed on the stem 91 and the robot manipulator arm speed drops to zero, stopping the end-effector 1 at the stem 91. At this point, the end-effector 1 is commanded to cut the stem 91 as described above.

### Fruit Transfer 400

With the fruit stem 91 pinched, the end-effector 1 is holding the fruit 90. The robot manipulator arm is commanded to place the fruit 90 over a storage container and then commanded to translate the jaw 30 distally, thereby releasing the fruit 90 from its pinching grasp and allowing the fruit 90 to fall into the storage container.

### Reset 500

After transferring harvested fruit, the robot manipulator arm returns to a home position and the process is the repeated for the next fruit in the tracking list.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. An end-effector for a robotic manipulator arm for robotic crop management, the end-effector comprising:
a chassis mountable on the robotic manipulator arm;
a jaw movably mounted on the chassis to permit translation of jaw on the chassis, the jaw at least partially defining a closed loop through which a horticultural object is able to pass;
a tactile sensor mounted on the end-effector configured to measure a force applied to the horticultural object by the end-effector as the horticultural object passes through the closed loop;
a cutter mounted on the chassis, the cutter configured to cut a portion of the horticultural object when the portion of the horticultural object is brought into contact with the cutter by translation of the jaw on the chassis; and,
a blade sheath housing the cutting blade therein when the cutting blade is not being used.

2. The end-effector of claim 1, wherein the chassis comprises parallel guide carriages situated at sides of the chassis, and the jaw comprises parallel sides, each of the sides of the jaw comprising a guide rail on which one of the parallel guide carriages are mounted, the guide rails sliding on the guide carriages as the jaw translates on the chassis.

3. The end-effector of claim 1, wherein the cutter comprises a cutting blade immovably mounted on the chassis, a cutting edge of the cutting blade oriented into the closed loop.

4. The end-effector of claim 1, wherein the jaw comprises at least one jaw roller oriented into the closed loop, the at least one jaw roller rotatable in response to the horticultural object moving through the closed loop and in contact with the at least one jaw roller.

5. The end-effector of claim 4, wherein the jaw comprises arms joined at an apex at a distal end of the end-effector and the at least one jaw roller comprises at least two jaw rollers, at least one of the at least two jaw rollers mounted on each of the arms.

6. The end-effector of claim 1, wherein the blade sheath is a translatable blade sheath mounted on the chassis, the blade sheath retractable in response to the jaw translating to bring the portion of the horticultural object into contact with the cutting edge of the cutting blade.

7. The end-effector of claim 6, wherein the blade sheath comprises latches that secure the blade sheath to the chassis and the jaw comprises latch releases that engage the latches to release the latches as the jaw translates so that the jaw contacts the blade sheath to push the blade sheath thereby unsheathing the cutting blade.

8. The end-effector of claim 6, wherein the blade sheath together with the jaw define the closed loop, and the blade sheath comprises at least one sheath roller rotatable in response to the horticultural object moving through the closed loop and in contact with the at least one sheath roller.

9. The end-effector of claim 1, wherein:
the chassis is fixedly mountable on the robotic manipulator arm,
the end-effector further comprises a rack-and-pinion mechanism and an actuator, whereby the actuator and a pinion gear are mounted on the chassis and a toothed rack is mounted on the jaw, wherein the pinion gear is rotatably connected to the actuator and operatively engaged with the toothed rack, wherein actuation of the actuator causes the jaw to translate linearly on the chassis.

10. The end-effector of claim 1, wherein the tactile sensor comprises a force-sensitive resistor.

11. The end-effector of claim 10, wherein the force-sensitive resistor is mounted on the chassis and the end-effector further comprises a floating bearing block mounted on the chassis between the force-sensitive resistor and the closed loop whereby the force applied to the horticultural object by the end-effector as the horticultural object passes through the closed loop is transmitted to the force-sensitive resistor through the floating bearing block.

12. The end-effector of claim 1, further comprising a gripper that grips the horticultural object when the cutter cuts the portion of the horticultural object when the portion of the horticultural object is brought into contact with the cutter by translation of the jaw on the chassis.

13. The end-effector of claim 12, wherein the gripper comprises a pinch gripper connected to the chassis and a jaw tab connected to the jaw, the pinch gripper and jaw tab having gripping surfaces between which the horticultural object is gripped.

14. The end-effector of claim 1, wherein the horticultural object is a fruit or vegetable.

15. The end-effector of claim 1, wherein the horticultural object is a cucumber.
